(19) United States
(12) Patent Application Publication
(10) Pub. No.: US 2003/0140146 A1
(43) Pub. Date: Jul. 24, 2003

(54) Method and system for interconnecting a Web server with a wireless portable communications device

(76) Inventors: Willard Stephen Akers, Louisville, KY (US); Brian Paul Rickabaugh, Louisville, KY (US); Michael Benjamin Starrner, Louisville, KY (US)

Correspondence Address: George L. Rideout, Jr., General Electric Company, Appliance Park 2-225, Louisville, KY, 40225, US

(21) Appl. No.: 10/052,661

(22) Filed: Jan. 23, 2002

(51) Int. Cl. G06F 15/16

(52) U.S. Cl. 709/227; 709/225

(57) ABSTRACT

Method and system for securely and quickly interconnecting a web server with a portable wireless communications device are provided. The method provides a gateway coupled to the server. The gateway includes a database for storing a plurality of active session data uniquely identifying each of a plurality of users authorized to gain access to the server. The method allows to transmit a present transaction request including a unique identifier from the wireless device to the gateway. The method further allows to relate the present transaction request against the active session data in the database to determine whether or not the unique identifier in the transaction request matches a respective active session data. In the event no match of the transaction request against any active session data is determined, the method allows to transmit a login screen so that, upon the user providing authentication credentials through the login screen, the user can proceed with the transaction request. In the event a match is determined, the method permits the user to proceed through the transaction request without the user having to reenter the authentication credentials.

The present invention is generally related to Web-based communication, and, more particularly, the present invention is related to system and method for securely and quickly interconnecting a Web server with a wireless portable communications device.

Since the advent of Web-based communications, various communication techniques have evolved to meet the ever-increasing needs for access to information. Among the more familiar types of systems used for Web-based communications are wire-based communication systems that use conducting wires or optical fiber links to connect users. One of the principal disadvantages of a wire-based communication network is that users are limited to specific locations where wired connections are available. Another disadvantage is that wire-based communication networks usually require dedicated lines, which can be expensive.

The assignee of the present invention has recognized that accurate, and timely information are key factors to the success of business owners in a global market place. To facilitate their business objectives, the assignee of the present invention, through its GE Appliances business organization, has developed a Web-based communications system, referred to as GE CustomerNet system, that allows suppliers, distributors, and retailers to securely access detailed information regarding their business transactions.

Recently wireless data communication networks have emerged that enable Web-based information exchange by sending and receiving data through high frequency radio signals. Thus, it would be desirable by the assignee of the present invention to securely and quickly provide Internet-based access to customers and suppliers that would like the flexibility afforded by mobile wireless communication for obtaining information regarding their business transactions.

Various consumer electronic devices, such as wireless Personal Digital Assistant (PDA) devices, Handheld Personal Computers (HPCs), cellular phones, etc., have been recently developed to provide World Wide Web (WWW) wireless access to potentially millions of mobile users. Presently, these portable devices generally constitute an affordable, easy-to-use mobile tool designed to complement, not necessarily replace, desktop, laptop and notebook computers. Because of their size and weight limitations, these portable devices presently cannot match the processing and storage capabilities enabled by personal computers. For example, such mobile devices may limit the file size of the messages communicated therewith if practical download times are desired. Unfortunately, simply limiting the file size may not provide the user with a sufficient amount of information in order to reach a decision regarding, for example, a purchasing transaction.

Further, many of the applications presently enabled by such devices have not generally stored “Session” information in the portable device due to software limitations of such devices. Session information generally refers to a computer-readable file including information that would enable to uniquely and persistently identify throughout a session a user who has been granted access privileges to a Web site. However, in the absence of stored session information in the device, every time that the user makes a new transaction request, the user is forced to repetitively perform a login procedure to provide appropriate authentication credentials prior to continuing with the any new transaction request. This leads to incrementally slower and costlier transactions due to the additional time spent by the user to login every time the user makes a transaction request.

In view of the foregoing discussion it would be desirable to provide techniques that avoid the shortcomings that users may experience when using a portable wireless communications device for accessing a secure Web site. It would be further desirable that such techniques result in a gateway with enhanced speed, performance, and compatibility when interconnecting with a portable wireless device. By providing a fast and low-cost connection, in accordance with aspects of the present invention, increased versatility in communications with mobile users is achieved and the issues outlined above are to a substantial degree overcome.

### BRIEF SUMMARY OF THE INVENTION

Generally, the present invention fulfills the foregoing needs by providing in one aspect thereof a method for securely and quickly interconnecting a web server with a portable wireless communications device. The method provides a gateway coupled to the server. The gateway includes a database for storing a plurality of active session data uniquely identifying each of a plurality of users authorized to gain access to the server. The method allows to transmit a present transaction request including a unique identifier from the wireless device to the gateway. The method further allows to relate the present transaction request against the active session data in the database to determine whether or not the unique identifier in the transaction request matches a respective active session data. In the event no match of the transaction request against any active session data is determined, the method allows to transmit a login screen so that, upon the user providing authentication credentials through the login screen, the user can proceed with the transaction request. In the event a match is determined, the method permits the user to proceed through the transaction request without the user having to reenter the authentication credentials.

The present invention further fulfills the foregoing needs by providing in another aspect thereof, a system for securely and quickly interconnecting a web server to a portable wireless communications device. The system includes a gateway coupled to the server. The gateway includes a database storing a plurality of active session data uniquely identifying each of a plurality of users authorized to gain access to the server. A link is configured to transmit a present transaction request including a unique identifier from the wireless device to the gateway. A processor in the gateway is configured to relate the present transaction request against the active session data in the database to determine whether or not the unique identifier in the transaction request matches a respective active session data. The gateway is configured to perform the following actions:

in the event no match of the transaction request against any active session data is determined, transmitting a login screen so that, upon the user providing authentication credentials through the login screen, the user can proceed with the transaction request;

in the event a match is determined, permitting the user to proceed through the transaction request without the user having to reenter the authentication credentials.

### BRIEF DESCRIPTION OF THE DRAWINGS

The features and advantages of the present invention will become apparent from the following detailed description of the invention when read with the accompanying drawings in which:

FIG. 1 illustrates a block diagram representation of an exemplary embodiment of a system for interconnecting a web server to a portable wireless communications device.

FIG. 2 illustrates an exemplary Web page and corresponding mapping of transactional code snippets for the Web page before and after compression in accordance with aspects of the present invention.

FIG. 3 illustrates an exemplary flow diagram for the mapping of FIG. 2.

### DETAILED DESCRIPTION OF THE INVENTION

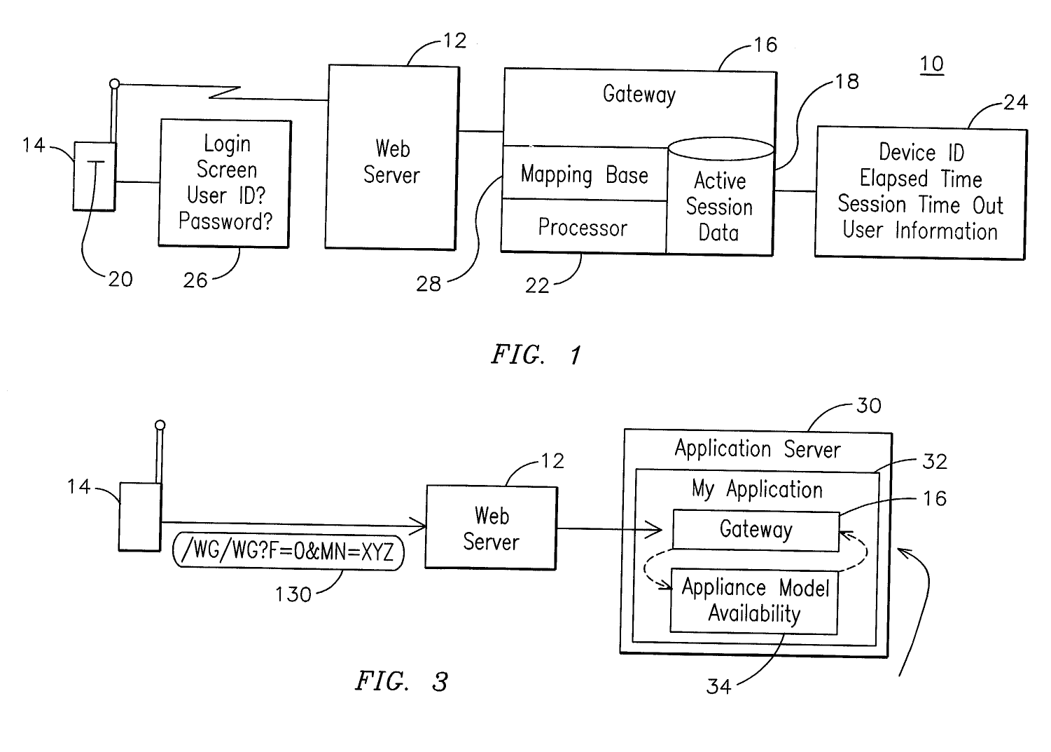

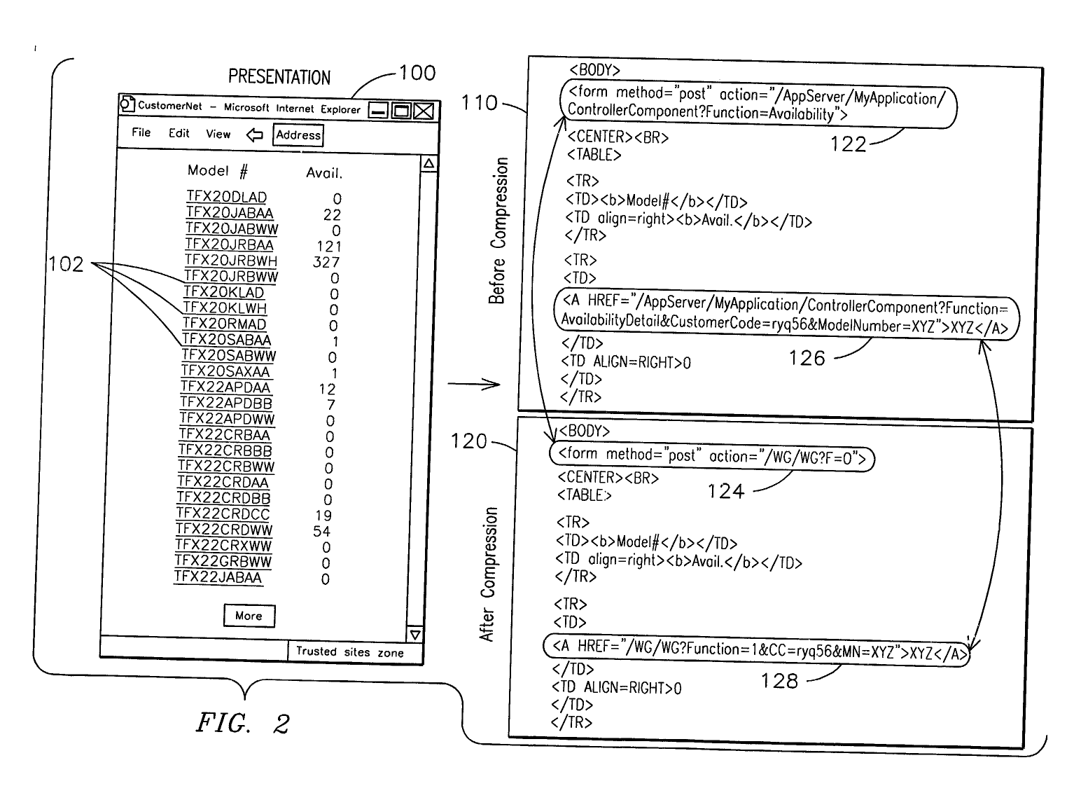

FIG. 1 illustrates an exemplary embodiment of a system 10 for securely and quickly interconnecting a web server 12 to a portable wireless communications device 14, such as such as wireless Personal Digital Assistant (PDA) device, Handheld Personal Computer (HPC), cellular phone, etc. As shown in FIG. 2, the system includes a gateway 16 coupled to the server 12. The gateway includes a database 18 for storing a plurality of active session data uniquely identifying each of a plurality of users authorized to gain access to the server 12. As represented in block 24, each session data may include respective data fields indicative of a unique device identifier (ID), time elapsed from the last transaction request by a respective user, a session time out value, and user-related information, such as zip code, password, etc.

As further shown in FIG. 1, a link 20, e.g., a hyperlink, is configured to transmit upon being clicked or otherwise selected by the user a present transaction request including a unique identifier from the wireless device to the gateway. Examples of a transaction request may include: an order of respective goods, an order for services related to the goods, order status information, order update, information regarding the goods and/or services, model availability and pricing, replacement parts availability and pricing, training information, etc.

The gateway 16 includes a processor 22 configured to relate the present transaction request against the active session data in the database 18 to determine whether or not the unique identifier in the transaction request matches a respective active session data. More particularly, the gateway is configured to perform the following actions: in the event no match of the transaction request against any active user session data is determined, then Web server 12 transmits or downloads a login screen 26 so that, upon the user providing authentication credentials through the login screen, e.g., user ID and password, the user can proceed with the transaction request; or, in the event a match is determined, permitting the user to proceed through the transaction request without the user having to reenter the authentication credentials.

Processor 22 is further configured to determine whether the time elapsed from the last transaction request by that respective user is within the session time out value. For example, in the event the time elapsed from the last transaction request by that respective user is within the session time out value, then the active session data for that user continues to be usable by the gateway. Conversely, in the event the time elapsed from the last transaction request by that respective user exceeds the session time out value, then the active session data for that user is inactivated, and thus the user would be required to provide the authentication credentials through the login screen to continue with the transaction request. In one exemplary embodiment, the time out value may have a value of 30 minutes. It will be appreciated, however, that the present invention is not limited to ant specific time out value since other time out values could be selected based on the requirements of the application and factors, such as average session duration, customer usage patterns, etc.

In another aspect of the present invention, as will be now appreciated by those skilled in the art, it is desirable to increase the efficiency of the wireless transaction by reducing the size of the code representation communicated by the wireless portable device without compromising the amount of information that may be communicated by the device. FIG. 2 illustrates an exemplary Web page 100 including a plurality of hyperlinks 102 for a plurality of appliance models and respective availability. Blocks 110 and 120 illustrate respective code snippets for the page 100 before and after compression respectively. By way of example, block 110 illustrates one exemplary string of uncompressed transactional code 122 that maps using a mapping base 28 (FIG. 1) into a corresponding string of compressed code 124 in block 120. Another example of mapping each transaction request into corresponding strings of compressed and uncompressed transactional code is represented in block 110 by another exemplary string of uncompressed transactional code 126 that maps into a corresponding string of compressed code 128 in block 124. In one exemplary embodiment it was estimated that in applications where there are a relatively large number of links, the compression technique illustrated above resulted in 60% smaller file size. It will be appreciated that for users who pay for wireless transmissions per kilobyte downloaded (or equivalent) this aspect of the present invention provides significant cost savings. Moreover, smaller file sizes would result in faster download times, since generally a 60% reduction in file size would result in download times that are also 60% faster.

FIG. 3 illustrates an exemplary flow diagram of the mapping technique discussed in the context of FIG. 2. Assuming that an active session has been established, as discussed in the context of FIG. 1, then when a transaction request from the wireless device 14 reaches the gateway 16, the following actions may be performed:

1. The gateway 16 receives each string of compressed transactional code corresponding to the transaction request transmitted by the device 14 and maps the string of compressed transactional code into a corresponding string of uncompressed code. For example, a request to access information from a suitable application server 30 through a program 32 identified as “My Application” regarding information indicative of availability of a given appliance model, such as may be stored in a database 34, would correspond to a string of compressed code 130, as exemplarily represented by the following string of compressed code.

/WG/WG?F=O&MN=XYZ

The string of compressed code 130 would be mapped to a corresponding string of uncompressed code, as exemplarily represented by the following string of uncompressed code.

/AppServer/MyApplication/ControllerComponent?Function=Availability&ModelNo=XYZ&ResultPage=Availability3

2. The request is then forwarded to the appropriate application component.

3. If the component requests a session, the gateway 16 passes the session ID to the component, if there is one. If not, the gateway 16 would accept a new session ID from the component.

4. Once the application component finishes processing the request, the response is received by the Wireless Gateway and passed back to the web server.

In operation, the present invention enables the GE CustomerNet wireless application to better serve the needs of customers by offering to those customers the flexibility of being away from their personal computers and yet with the use of readily available consumer electronic devices, such as PDAs and similar tools, those customers are now able to access essentially all the information and decision-making tools they need to make a transaction regardless of their location. The present invention can be embodied in the form of computer-implemented processes and apparatus for practicing those processes. The present invention can also be embodied in the form of computer program code containing computer-readable instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose computer, the computer program code segments configure the computer to create specific logic circuits or processing modules.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A method for securely and quickly interconnecting a web server with a portable wireless communications device, the method comprising:
providing a gateway coupled to the server, the gateway including a database storing a plurality of active session data uniquely identifying each of a plurality of users authorized to gain access to the server;
transmitting a present transaction request including a unique identifier from the wireless device to the gateway;
relating the present transaction request against the active session data in the database to determine whether or not the unique identifier in the transaction request matches a respective active session data;
in the event no match of the transaction request against any active session data is determined, transmitting a login screen so that, upon the user providing authentication credentials through the login screen, the user can proceed with the transaction request;
in the event a match is determined, permitting the user to proceed through the transaction request without the user having to reenter the authentication credentials.

2 The method of claim 1 wherein the active session data includes respective data fields indicative of time elapsed from the last transaction request by a respective user and a session time out value.

3. The method of claim 2 wherein the relating of the present transaction request to the active session data includes determining whether the time elapsed from the last transaction request by that respective user is within the session time out value.

4. The method of claim 3 wherein in the event the time elapsed from the last transaction request by that respective user is within the session time out value, the active session data for that user continues to be usable by the gateway.

5. The method of claim 3 wherein in the event time elapsed from the last transaction request by that respective user exceeds the session time out value, the active session data for that user is inactivated, and thus requiring the user to provide the authentication credentials through the login screen to continue with the transaction request.

6. The method of claim 1 further comprising mapping each transaction request into corresponding strings of compressed and uncompressed transactional code.

7. The method of claim 5 wherein the transaction request transmitted by the wireless device comprises at least one string of compressed transactional code.

8. The method of claim 6 further comprising translating the at least one string of compressed transactional code transmitted by the wireless device into a corresponding string of uncompressed code for the requested transaction.

9. The method of claim 1 wherein the transaction request comprises a transaction request selected from the group comprising requesting an order of respective goods, requesting an order for services related to the goods, requesting order status information, requesting an order update, requesting information regarding the goods and/or services.

10. A system for securely and quickly interconnecting a web server to a portable wireless communications device, the system comprising:
a gateway coupled to the server, the gateway including a database storing a plurality of active session data uniquely identifying each of a plurality of users authorized to gain access to the server;
a link configured to transmit a present transaction request including a unique identifier from the wireless device to the gateway; and
a processor in the gateway configured to relate the present transaction request against the active session data in the database to determine whether or not the unique identifier in the transaction request matches a respective active session data, the gateway configured to perform the following actions:
in the event no match of the transaction request against any active session data is determined, transmitting a login screen so that, upon the user providing authentication credentials through the login screen, the user can proceed with the transaction request;
in the event a match is determined, permitting the user to proceed through the transaction request without the user having to reenter the authentication credentials.

11. The system of claim 10 wherein the active session data includes respective data fields indicative of time elapsed from the last transaction request by a respective user and a session time out value.

12. The system of claim 11 wherein the processor is further configured to determine whether the time elapsed from the last transaction request by that respective user is within the session time out value.

13. The system of claim 12 wherein in the event the time elapsed from the last transaction request by that respective user is within the session time out value, the active session data for that user continues to be usable by the gateway.

14. The system of claim 12 wherein in the event time elapsed from the last transaction request by that respective user exceeds the session time out value, the active session data for that user is inactivated, and thus requiring the user to provide the authentication credentials through the login screen to continue with the transaction request.

15. The system of claim 10 further comprising a mapping base mapping each transaction request into corresponding strings of compressed and uncompressed transactional code.

16. The system of claim 15 wherein the transaction request transmitted by the wireless device comprises at least one string of compressed transactional code.

17. The system of claim 16 wherein the processor is further configured to translate the at least one string of compressed transactional code transmitted by the wireless device into a corresponding string of uncompressed code for the requested transaction.

18. The system of claim 10 wherein the transaction request comprises a transaction request selected from the group comprising requesting an order of respective goods, requesting an order for services related to the goods, requesting order status information, requesting an order update, requesting information regarding the goods and/or services.
